(19) United States
(12) Patent Application Publication
(10) Pub. No.: US 2025/0102715 A1
(43) Pub. Date: Mar. 27, 2025

(54) ELECTRONIC DEVICE INCLUDING AN ENCLOSURE COMPONENT PROVIDING A DEPTH EFFECT

(71) Applicant: Apple Inc., Cupertino, CA (US)

(72) Inventors: Chinmay Peshave, Cupertino, CA (US); Nanish Mittal, Cupertino, CA (US)

(21) Appl. No.: 18/786,099

(22) Filed: Jul. 26, 2024

Related U.S. Application Data
(60) Provisional application No. 63/539,646, filed on Sep. 21, 2023.

(51) Int. Cl. G02B 5/26; G04G 17/08; G06F 1/16

(52) U.S. Cl. CPC G02B 5/26; G04G 17/08; G06F 1/1626; G06F 1/163

(57) ABSTRACT

An enclosure component, such as a display cover, which produces an optical effect is disclosed. In some cases, the optical effect provides a depth effect, such as the depth effect produced by a bevel. Electronic device enclosures and electronic devices that include the enclosure components are also disclosed.

### CROSS-REFERENCE TO RELATED APPLICATION(S)

This application is a nonprovisional application of and claims the benefit of U.S. Provisional Patent Application No. 63/539,646, filed Sep. 21, 2023, and titled “Electronic Device Including an Enclosure Component Providing a Depth Effect,” the disclosure of which is hereby incorporated herein by reference in its entirety.

### FIELD

The described embodiments relate generally to an enclosure component that provides an optical effect, such as a depth effect. More particularly, the present embodiments relate to an enclosure component that includes an optical assembly that produces the optical effect, as well as an enclosure and an electronic device including this enclosure component.

### BACKGROUND

An electronic device may include a display and a cover provided over the display. The display may have an active area that includes pixels and an inactive area along a periphery of the active area. Some conventional covers are formed from a transparent sheet that may be flat or may have a curved peripheral portion. The examples described herein relate to techniques for both masking the inactive area of a display and creating particular optical effects at a periphery of a display.

### SUMMARY

The disclosure provides an enclosure component, such as a display cover, which produces an optical effect. In some cases, the optical effect provides a depth effect to a portion of the enclosure component. In some examples, the optical effect may simulate the optical effect produced by a bevel. The disclosure also provides electronic device enclosures and electronic devices that include the enclosure components described herein.

When the enclosure component is assembled with the rest of the enclosure, the depth effect may create the appearance that enclosure component has a thickness variation that is not present in the actual component. As an example, the depth effect may create the appearance that enclosure component defines a bevel. The depth effect may also create an appearance of a boundary between the perceived bevel region and another region of the enclosure component.

In some examples, a display cover defines a window portion over an active area of a display and the optical effect is created in a peripheral portion of the display cover that surrounds the window portion. The window portion may be a central portion of the display cover. In some cases, a thickness of the peripheral portion may appear to be less than that of the window portion even when thickness of the peripheral portion is about the same as or greater than that of the window portion. For example, the display cover may appear to have a beveled interior surface in the peripheral portion. The depth effect may be visible when display pixels in the active area are not illuminated (i.e., when the display is off). When the peripheral portion appears to have an interior beveled surface, this effect may also be visible when the display is on.

The techniques for producing a depth effect described herein can therefore simplify the process for manufacturing the enclosure component. The enclosure component may include a cover member, which may be a transparent cover member. For example, when an actual change in the thickness of the cover member would conventionally be achieved by one or more operations such as machining, polishing, or molding, the techniques described herein can allow simpler and/or fewer operations to be used. When the cover member is made from a brittle material, eliminating one or more machining operations may reduce the possibility of cracks or other defects resulting from the machining operations, thereby increasing the durability of the enclosure component.

The optical effect may be provided at least in part by an optical assembly provided along an interior surface of a portion of the enclosure component. The external viewer may perceive the optical effect at least in part due to perceiving a difference in appearance between the portion of the enclosure component that is provided with the optical assembly and another portion of the enclosure component. Alternately or additionally, the external viewer may perceive the optical effect at least in part due to perceiving a transition (e.g., a boundary) between the appearance of this portion of the enclosure component and the other portion of the enclosure component.

The optical assembly may include a set of surface features along an interior surface of the enclosure component and an optical coating disposed over the set of surface features. In some examples, the surface features may be formed at the interior surface of the enclosure component, such as by depositing a material on or over the interior surface of a cover member of the enclosure component. In other examples, the surface features may be formed into the interior surface of the cover member, such as by an etching process. In some cases, each of the set of surface features and the optical coating may contribute to the optical effect. The additional description of surface features and optical coatings provided herein, including the description provided with respect to FIGS. 1A, 1B, and 7, is generally applicable and is not repeated here.

The optical assembly may also include one or more light absorbing coatings may be disposed along the interior surface of a portion of the enclosure component. As an example, a light absorbing coating may be disposed at or over the interior surface of a peripheral portion of a cover member of the enclosure component between the surface features and another portion of the cover member. As another example, a light absorbing coating may be disposed over the optical coating. The light absorbing coating may be an ink coating that includes a pigment that absorbs light in the visible spectrum.

The disclosure provides an electronic watch comprising a display, a cover, a housing coupled to the cover and at least partially surrounding the display, and a band coupled to the housing. The cover comprises a cover member defining a window portion positioned over the display, a set of surface features formed along a rear surface of the cover member and a coating stack surrounding the window portion at the rear surface of the cover member, the coating stack comprising an optical coating disposed over the set of surface features and comprising a least one layer having a first index of refraction different than a second index of refraction of the set of surface features and a rear ink coating disposed over at least a portion of the optical coating.

The disclosure also provides an electronic device comprising a display and an enclosure comprising a cover positioned over the display, the cover comprising a cover member defining a transparent window portion, a first coating stack comprising a patterned transparent coating disposed over a first region of a rear surface of the cover member, a first portion of an optical coating disposed over the patterned transparent coating, and a first portion of a rear ink coating disposed over the first portion of the optical coating, and a second coating stack defining a border around the transparent window portion at the rear surface of the cover member and comprising a front ink coating disposed over a second region of the rear surface that is surrounded by the first region of the rear surface, a second portion of the optical coating disposed over the front ink coating, and a second portion of the rear ink coating disposed over the second portion of the optical coating.

The disclosure further provides an electronic device comprising a display, a housing at least partially surrounding the display, and a cover coupled to the housing and comprising a transparent cover member defining a central portion positioned over an active area of the display and a peripheral portion surrounding the central portion and an optical assembly at the peripheral portion of the transparent cover member and comprising, a set of surface features formed along a rear surface of the transparent cover member, a first ink coating defining a border around the active area of the display and disposed over the rear surface, the first ink coating at least partially surrounded by the set of surface features, an optical coating disposed over the first ink coating, the set of surface features, and along at least a portion of a side surface of the transparent cover member, and a second ink coating disposed over a portion of the optical coating.

### BRIEF DESCRIPTION OF THE DRAWINGS

The disclosure will be readily understood by the following detailed description in conjunction with the accompanying drawings, wherein like reference numerals designate like elements.

FIG. 1A shows a first view of an example electronic device.

FIG. 1B shows another view of the electronic device of FIG. 1A.

FIG. 2 shows an example partial cross-sectional view of a beveled cover for an electronic device.

FIG. 3 shows an example partial cross-sectional view of the electronic device of FIG. 1A.

FIG. 4 shows another example partial cross-sectional view of the electronic device of FIG. 1A.

FIG. 5A shows a first view of another example electronic device.

FIG. 5B shows a second view of the electronic device of FIG. 5A.

FIG. 6 shows a front view of a cover for an electronic device.

FIG. 7 shows a partial cross-section view of a cover for an electronic device.

FIG. 8 shows a rear view of a cover including a set of surface features on an interior surface of a cover member.

FIG. 9A shows an example of an enlarged view of a set of surface features.

FIG. 9B shows another example of an enlarged view of a set of surface features.

FIG. 10A shows an example of a partial cross-section view of a set of surface features of an enclosure component.

FIG. 10B shows another example of a partial cross-section view of a set of surface features of an enclosure component.

FIG. 11A shows another example of a partial cross-section view of a set of surface features formed into a cover member.

FIG. 11B shows another example of a partial cross-section view of a set of surface features formed into a cover member.

FIG. 11C shows another example of a partial cross-section view of a set of surface features formed into a cover member.

FIG. 11D shows another example of a partial cross-section view of a set of surface features formed into a cover member.

FIG. 12 shows a block diagram of an example electronic device.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred implementation. To the contrary, the described embodiments are intended to cover alternatives, modifications, and equivalents as can be included within the spirit and scope of the disclosure and as defined by the appended claims.

The following disclosure relates to an enclosure component, such as a display cover, which produces an optical effect. In some cases, the optical effect provides a depth effect to a portion of the enclosure component. In some examples, the optical effect may simulate the optical effect produced by a bevel. In some examples, the optical effect changes with increasing distance from a side surface of the enclosure component. The disclosure also provides electronic device enclosures and electronic devices that include the enclosure components described herein.

When the enclosure component is assembled with the rest of the enclosure, the depth effect may create the appearance that enclosure component has a thickness variation (alternately, depth variation) that is not present in the actual component. In some embodiments, at least a portion of a cover member of the enclosure component has a substantially uniform thickness even though the depth effect may create the appearance of a thickness variation. For example, an exterior surface of the portion of the cover member may be substantially flat and substantially opposite to (e.g., substantially parallel to) a substantially flat interior surface of the cover member. As an example, the depth effect may create the appearance that enclosure component defines a bevel. In some cases, a peripheral portion of the cover may appear to have a depth (from the front to the rear surface) that is less than a depth of a central portion of the cover. The depth effect may also create an appearance of a boundary between the perceived bevel region and another region of the enclosure component.

In some examples, a display cover defines a window portion over an active area of a display and the optical effect is created in a peripheral portion of the display cover that surrounds the window portion. The window portion may be a central portion of the display cover. In some cases, a thickness of the peripheral portion may appear to be less than that of the window portion even when thickness of the peripheral portion is about the same as or greater than that of the window portion. For example, the display cover may appear to have a beveled interior surface in the peripheral portion. The depth effect may be visible when display pixels in the active area are not illuminated (i.e., when the display is off). When the peripheral portion appears to have an interior beveled surface, this effect may also be visible when the display is on.

The techniques for producing a depth effect described herein can therefore simplify the process for manufacturing the enclosure component. The enclosure component may include a cover member, which may be a transparent cover member. For example, when an actual change in the thickness of the cover member would conventionally be achieved by one or more operations such as machining, polishing, or molding, the techniques described herein can allow simpler and/or fewer operations to be used. When the cover member is made from a brittle material, eliminating one or more machining operations may reduce the possibility of cracks or other defects resulting from the machining operations, thereby increasing the durability of the enclosure component.

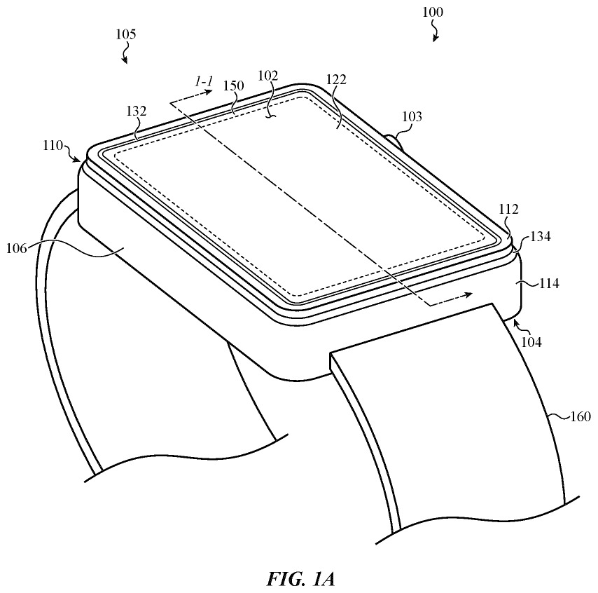

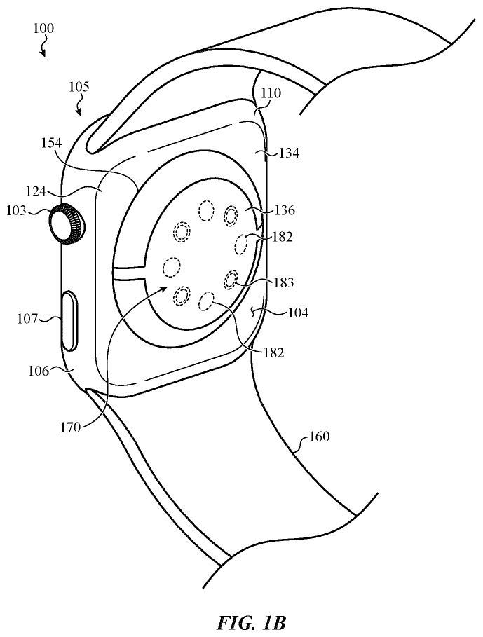

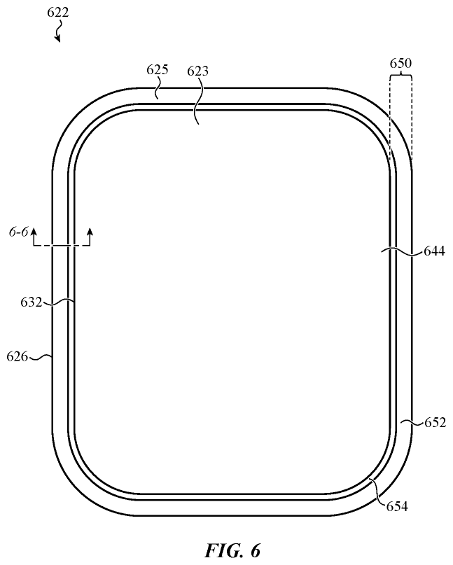

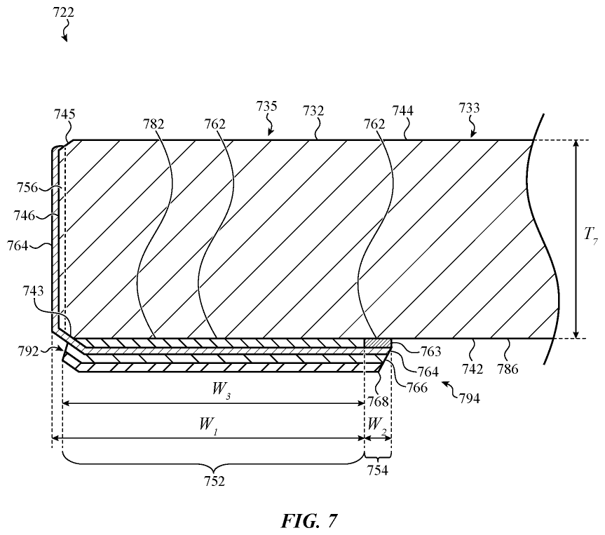

The optical assembly may include a set of surface features along an interior surface of the enclosure component and an optical coating disposed over the set of surface features. In some examples, the surface features may be formed by depositing a material on or over the interior surface of a cover member of the enclosure component. In other examples, the surface features may be formed into the interior surface of the cover member, such as by an etching process. The optical coating may conform to the surface features in some examples. In some cases, each of the set of surface features and the optical coating may contribute to the optical effect. The optical assembly may obscure an inactive portion of the display and/or other internal components of the electronic device from view. In some cases, the optical assembly may obscure an internal feature of the enclosure (e.g., an internal ledge) from view. The additional description of surface features and optical coatings provided herein, including the description provided with respect to FIGS. 1A, 1B, and 7, is generally applicable herein and is not repeated here.

The optical assembly may also include one or more light absorbing coatings that may be disposed along the interior surface of a portion of the enclosure component. The light absorbing coating may obscure viewing of one or more internal components of the electronic device and/or may contribute to an optical effect. As an example, a light absorbing coating may be disposed on or over the interior surface of a peripheral portion of a cover member between the surface features and another portion of the cover member. As another example, a light absorbing coating may be disposed over the optical coating. The light absorbing coating may be an ink coating that includes a pigment that absorbs light in the visible spectrum.

These and other embodiments are discussed below with reference to FIGS. 1A-12. However, those skilled in the art will readily appreciate that the detailed description given herein with respect to these figures is for explanatory purposes only and should not be construed as limiting.

FIGS. 1A and 1B show an example portable electronic device. The electronic device 100 may be wearable electronic device, such as an electronic watch (e.g., a smartwatch) and/or an electronic heath monitoring device. In other examples, the electronic device may have the form of a mobile phone, a notebook computing device, a tablet computing device, a desktop computing device, a display monitor, a portable media player, a smart speaker device, or another type of portable electronic device. A band 160 is attached to the housing 110 and configured to secure the electronic device 100 to a user.

In the example of FIGS. 1A and 1B, the electronic device 100 includes an enclosure 105. The enclosure 105 includes a cover 122, a cover 124, and a housing 110. The cover 122 may alternately be referred to as a front cover or a first cover and the cover 124 may alternately be referred to as a rear cover or a second cover.

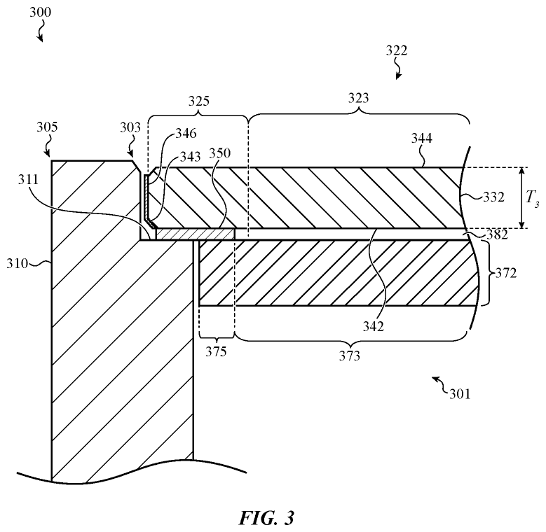

The enclosure 105 of FIG. 1B defines an internal cavity (e.g., 301 and 401 of FIGS. 3 and 4) and electronic components such as a display are positioned within the cavity. The display (e.g., 372 of FIG. 3), which may alternately be referred to herein as a display assembly, may produce graphical output which is transmitted through the cover 122 of the enclosure 105. In some cases, the display is a touch-sensitive display. The display may include a liquid-crystal display (LCD), a light-emitting diode (LED) display, an LED-backlit LCD display, an organic light-emitting diode (OLED) display, an active layer organic light-emitting diode (AMOLED) display, and the like. In some embodiments, the display may be attached to (or may abut) the cover 122 (as shown in FIG. 3). The display may have an active area that includes pixels and an inactive area. The inactive area may define a border around the active area.

The electronic device 100 may further include a crown module that is positioned at least partially within an opening formed within the enclosure 105. The crown module may include an input member 103 (e.g., a dial) having an outer surface configured to receive a rotary user input. The crown module may be offset with respect to a centerline of the enclosure component 110 (between the top and the bottom of the enclosure member). The offset may be toward the top or towards the bottom of the enclosure component 110. As shown in FIG. 1B, the electronic device 100 also includes the input member 107 (e.g., a button).

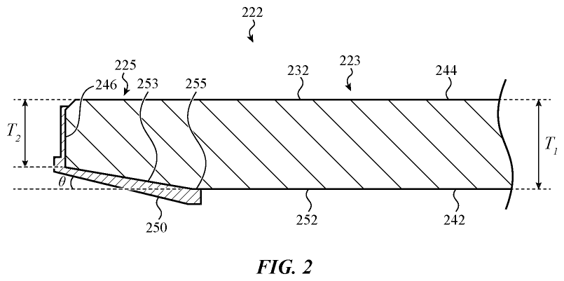

The cover 122 at least partially defines a front surface 102 of the electronic device. As previously discussed, the cover 122 may produce an optical effect. In some examples, the optical effect provides a depth effect to a portion of the cover 122. In further examples, the optical effect provides a depth effect and/or a refractive effect to a portion of the cover 122. In some cases, the optical effect may simulate the optical effect of a bevel. The additional description of these optical effects provided with respect to FIGS. 2 through 4 and 7 is generally applicable herein and is not repeated here. In some embodiments, the cover 122 may define a substantial entirety (e.g., at least 90%) of the front surface of the electronic device.

The cover 122 is positioned over the display and may define a window portion that is positioned over the active area of the display and a peripheral portion that surrounds the window portion, as illustrated in FIGS. 3 and 4. The window portion of the display may be substantially transparent. In some embodiments, the optical effect is created in the peripheral portion of the cover by an optical assembly 150. For example, the cover 122 may appear to have a beveled interior surface in the peripheral portion. Each of the window portion and the peripheral portion may extend from an exterior surface to an interior surface of the cover 122. The exterior surface of the cover 122 may alternately be referred to herein as the front surface and the interior surface of the cover 122 may alternately be referred to herein as the rear surface. The window portion of the cover may be substantially transparent so that the graphical output from the display is clearly visible to a viewer. In some embodiments, the cover 122 may be positioned over one or more additional internal components of the electronic device 100.

The cover 122 includes a cover member 132. The cover member 132 may be substantially transparent. For example, the transmission of the cover member 132 (or the transparent portions thereof) may be at least 85%, 90%, or 95% over a visible wavelength range (e.g., the visible spectrum from about 380 nm to about 780 nm), and the haze may be less than about 5% or 1%. This transmission value may be an average value. Although the cover member 132 may define a window portion that is positioned over the active area of the display and a peripheral portion, each of the window portion and the peripheral portion of the cover member 132 may be transparent. In some embodiments, the cover member 132 may define a substantial entirety (e.g., at least 90%) of the exterior surface of the cover 122.

The cover member 132 may be formed from a glass material, a ceramic material (e.g., sapphire, other forms of alumina, or zirconia), a glass ceramic material, a polymer material, or a combination thereof (e.g., layers of different materials). In some embodiments, the exterior surface and at least part of the interior surface of the cover member 132 has a polished texture. In some cases, surface features may be formed along a region of the interior surface as described in more detail with respect to FIGS. 3-4, and 6 through 11D. In some embodiments the cover member 132 may have generally planar exterior and interior surfaces, as shown in the examples of FIGS. 3 and 4 and the optical effect may create the appearance that the interior surface of the cover has a beveled region or a curved region. In other embodiments, the cover member may have a contoured shape, such as a curved peripheral portion, and the optical effect may otherwise modify the appearance of the peripheral portion of the cover.

In embodiments described herein, the cover 122 includes an optical assembly. The optical assembly produces an optical effect and includes at least one optical element. The optical effect may create a difference in appearance between two portions of the cover 122. Alternately or additionally, the optical effect may create the appearance of a transition (e.g., a boundary) between the two portions of the cover 122.

In some cases, the optical effect provides a depth effect and/or a refractive effect to a portion of the cover 122. As one example, the depth effect may give the impression that the cover member 132 in this portion of the cover 122 varies in thickness although the actual thickness of that portion of the cover member 132 is generally uniform. In some cases, the perceived variation in thickness of the cover member 132 is similar to the variation in thickness resulting from an interior beveled surface. The depth effect and/or refractive effect may be due at least in part to the portion of the cover 122 appearing to reflect light similarly to a cover member 132 having an interior beveled surface. In some embodiments, the refractive effect may simulate bulk optic geometry. For example, the refractive effect may simulate a lens or non-uniform geometric bulk optic effect caused by a bevel or non-planar rear surface.

In embodiments, an optical effect is provided in a peripheral portion of the cover 122. For example, the cover member 132 may appear to have a beveled interior surface in the peripheral portion of the cover 122. The beveled interior surface may extend from an edge of the cover, an example of which is shown in FIG. 2. Alternately or additionally, the cover member 132 may appear to have a boundary between a beveled interior surface and a flat interior surface. The depth effect may be visible when display pixels in the active area are not illuminated (i.e., when the display is off). In some embodiments, the depth effect may also be visible when the display is on.

The optical assembly may include a set of surface features along an interior surface of the enclosure component, and this set of surface features may function as an optical element. In some cases, the interaction of light with the surface features may differ from the interaction of light with a smoother and more uniform surface, thereby contributing to the optical effect. For example, interaction of light with the surface features may contribute to a refractive effect. The surface features may be formed on and/or into the interior surface of the cover member, as discussed in more detail below.

The optical assembly may also include an optical coating that is disposed over the set of surface features and that functions as an optical element. The optical coating may conform to the surface features in some examples. The optical coating may affect the transmission and/or the reflection of light at the interface between the optical coating and the set of surface features. In embodiments, the optical coating is an interference coating that includes multiple layers configured to produce optical interference. When the surface features are provided along an interior surface of the enclosure component the optical coating may be disposed on a side surface of the enclosure component as well as being disposed over the surface features.

In embodiments, the set of surface features and the optical coating together contribute to the optical effect, such as the depth effect and/or the refractive effect. The combination of these two optical elements may be referred to herein as an optical structure. The optical structure may contribute to the impression that the cover member 132 in this portion of the cover 122 varies in thickness although the actual thickness of this portion of the cover member 132 is generally uniform. Alternately or additionally, the optical structure may lead to “bending” of at least some of the light exiting the exterior surface of the cover member 132.

The optical assembly may include one or more light absorbing coatings disposed on and/or over the interior surface of a portion of the cover member 132. The light absorbing coating may be an ink coating that includes a pigment or dye that absorbs light in the visible spectrum. As an example, a light absorbing coating may be disposed on the interior surface of a peripheral portion of the cover member 132 between the surface features and a window portion of the cover member 132. As another example, a light absorbing coating may be disposed over the optical coating. In some cases, a light absorbing coating may help to obscure internal components of the electronic device from view. Alternately or additionally, one or more of these light absorbing coatings may also contribute to the optical effect. The additional description of optical assemblies, sets of surface features, optical coatings, and ink coatings provided with respect to FIG. 7 is generally applicable herein and is not repeated here.

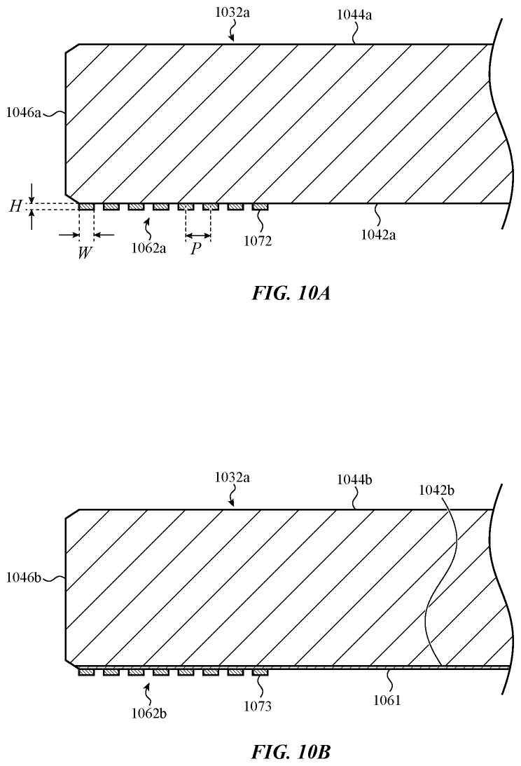

The cover 122 may also include one or more additional coatings. For example, the cover 122 may include an adhesion coating along an interior and/or an interior surface of the cover member 132, as described with respect to the example of FIG. 10B. As another example, the cover 122 may include a smudge resistant coating such as an oleophobic coating along the exterior surface of the cover member 132.

The cover 124 at least partially defines a rear surface 104 of the electronic device. In some cases, the rear surface 104 of the electronic device 100 may be substantially flat while in other cases the rear surface 104 may define a convex outer contour that protrudes outward or toward a wrist of a user, when the electronic device 100 is worn. As shown in FIG. 1B, the cover 124 includes a cover member 134 and a cover member 136. The cover 124 may include one or more electrodes 154 positioned along the rear surface 104. In the present example, the electrode(s) 154 are positioned at a surface of the cover member 136. In some embodiments, the electrode(s) 154 may additionally or alternatively be positioned along a surface of the cover member 134. The electrode(s) 154 may contact the skin of a user wearing the device and may be operably coupled to a processor and/or sensing circuitry of the electronic device 100. The electrode(s) 154 may be configured to measure or detect a voltage or other electrical property of the skin of a user when the electronic device 100 is worn by the user and the electronic device 100 may be configured to determine one or more physiological parameters of the user including, but not limited to, a heart rate, an electrocardiogram (ECG or EKG), atrial fibrillation (afib) detection, electrodermal activity (EDA sensor), and other similar skin-based or tissue based bio-measurements. The cover 124 may also include an exterior coating such as an oleophobic coating. The oleophobic coating may be applied to the cover member 134 and/or the cover member 136 in a similar fashion as previously described for the cover 122.

In the example of FIG. 1B, the cover 124 comprises a cover member 134. The cover member 134 may alternately referred to herein as a rear cover member or as a first rear member. The cover member 134 may partly define the rear surface 104 of the electronic device. In some cases, the cover member 134 may be integrally formed with the housing component and in other cases the cover member 134 may be coupled to the housing component 110. In some cases, the cover member 134 may be translucent or opaque to light in the visible spectrum. In some examples, the cover member 134 may be formed from a metal material or a ceramic material. For example, the cover member 134 may be formed of zirconia or another ceramic material. In some cases, the cover member 134 may be colored or tinted.

The cover 124 further comprises a cover member 136. The cover member 136 may alternately be referred to herein as a rear cover member, a second rear member, or as a rear crystal. The cover member 136 may be positioned over at least a portion of a sensing array 170 of the electronic device 100. The cover member 136 may be substantially transparent to light in the visible spectrum and the infrared spectrum. In some cases, the cover member 136 may be formed from a ceramic material (e.g., sapphire or transparent zirconia), a glass ceramic material, a glass material, a polymer material, and/or a composite material. The cover member 136 may be coupled to the cover member 134 with an adhesive, a fastener, or a combination thereof.

In the example of FIGS. 1A and 1B, the cover 124 is positioned over a sensing array 170. The sensing array 170 may include one or more sensor assemblies. In some embodiments, the sensing array 170 may include one or more optical modules. In the example of FIG. 1B, the sensing array 170 includes four optical modules 182 and four optical modules 183. The optical modules (182, 183) may include at least one visible light optical module and at least one infrared light optical module. As described herein, the optical modules (182, 183) may be configured to allow the device 100 to measure one or more physiological characteristics or other bio-measurements of the user including, without limitation, a photoplethysmogram (PPG), oxygen saturation (via a pulse oximeter sensor), or heart rate. The sensing array 170 may be referred to herein as a rear-facing sensing array since the optical modules are oriented towards the rear, rather than the front, of the device 100.

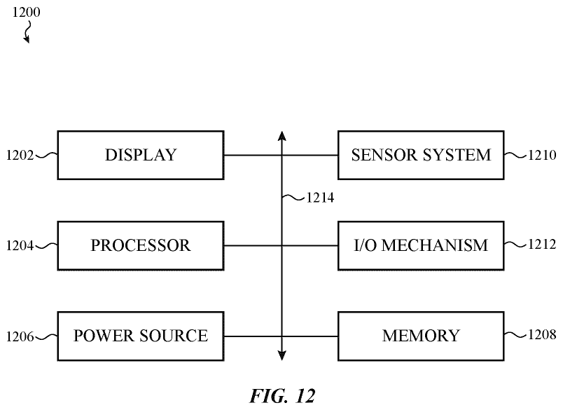

The electronic device 100 may include one or more sensors in addition to the sensing array 170. For example, electronic device 100 may include one or more of a microphone, a temperature sensor, a depth gauge, an accelerometer, and a gyroscope. These sensors may be positioned within the enclosure 105. The housing 110 may define one or more openings or ports to allow input to and/or output from the sensor(s). The sensors may be any of the device components described with respect to FIG. 12.

In the example of FIGS. 1A and 1B, the enclosure 105 also includes a housing 110. The housing 110 at least partially defines a side surface 106 of the electronic device. In additional examples, the cover 122 and/or the cover 124 may at least partially define a side surface of the electronic device. Each of the cover 122 and the cover 124 may be coupled to the housing 110.

In the example of FIG. 1A, the housing 110 includes an upper portion 112, a lower portion 114, and a dielectric portion 134. In embodiments, each of the upper portion 112 and the lower portion 114 is conductive. For example, each of the upper portion 112 and the lower portion 114 may be formed of a conductive material, such as a metal material. In some examples, a unitary housing member may define the upper portion 112 and the lower portion 114 and a portion bridging the upper portion 112 and the lower portion 114. In some cases, the housing 110 also includes a support plate and/or other internal structural components that are used to support internal electronic circuitry or electronic components.

In some embodiments, a metal portion of the housing 110 may be formed from an aluminum alloy, a titanium alloy, a magnesium alloy or steel. A dielectric portion of the housing may be formed of a (solid) dielectric material such as a polymer, silica, a ceramic material such as zirconia, alumina and/or titanium dioxide, or a combination thereof (e.g., a composite of particles of silica and/or a ceramic in a polymer matrix). As referred to herein, an enclosure component or member formed from a particular material, such as a metal material, may also include a relatively thin coating of a different material along one or more surfaces, such as an anodization layer, a physical vapor deposited coating, a paint coating, a primer coating (which may include a coupling agent), or the like.

In addition, the electronic device 100 may include one or more device components that may be part of a wireless communication system. As examples, the wireless communication system may be an RF or an IR communication system. An RF communication system may operate at one or more of a “low band” (e.g., less than 1 GHz, such as about 400 MHz to less than 1 GHz, about 600 MHz to about 900 MHz, or 600 MHz to 700 MHZ), a “mid-band” frequency range (e.g., about 1 GHz to about 6 GHz, such as about 1 GHz to about 2.6 GHZ, about 2 GHz to about 2.6 GHz, about 2.5 GHz to about 3.5 GHZ, or about 3.5 GHz to about 6 GHz), or a “high-band” frequency range (e.g., about 24 GHz to about 45 GHZ, about 57 GHz to about 64 GHz, or about 64 GHz to about 71 GHz), or a frequency range from about 1 GHz to about 10 GHz. As previously discussed, a component of an RF communication system may include an RF antenna configured to radiate a radio-frequency (RF) signal. The RF antenna may be configured to operate at one or more desired RF frequency ranges or RF frequency bands.

The electronic device 100 may include an antenna that is configured to communicate via one or more wireless communication protocols or standards. Wireless communication protocols and standards may include established protocols and standards such as IEEE 802.11x, GSM, LTE, CDMA, TDMA, 3G, 4G, 5G, Bluetooth, Bluetooth Low Energy (BLE), ISO/IEC 18000-3, Wi-Fi, Radio-frequency identification (RFID), Near-Field Communication (NFC), Global Positioning System (GPS) or any other target wireless communication protocol or standard (including yet-to-be-developed protocols and/or standards). In some cases, the electronic device 100 may include one or more antennas that include elements that are configured to communicate via a 5G wireless protocol (including millimeter wave and/or 6 GHz communication signals), a GPS standard, an LTE standard, or the like. For example, the GPS electronics may use L1 (L1C), L2 (L2C), L5, L1+L5, and other GPS signal bands in order to estimate the location of the electronic device 100.

The electronic device may include one or more additional components such as a processor, control circuitry, memory, an input/output mechanism, a power source (e.g., battery), a charging assembly (e.g., a wireless charging assembly), a network communication interface, and the like. Components of a sample electronic device are discussed in more detail below with respect to FIG. 12 and the description provided with respect to FIG. 12 is generally applicable herein.

FIG. 2 shows an example partial cross-sectional view of a cover 222 that includes a beveled region. The cover 222 may be an example of beveled cover that may be suitable for use over a display of an electronic device. The cover 222 includes a cover member 232 that defines the beveled region 253 and also includes a coating 250 located in the peripheral portion 225 of the cover 222. The beveled region 253, individually or in combination with the coating 250, may produce a depth and/or a refractive effect. The cross-sectional view of FIG. 2 may be along a cross-section that spans a width or a length of the cover.

The cover member 232 defines a planar exterior surface 244 that extends across the window portion 223 and most of the peripheral portion 225 of the cover 222. The interior surface 242 is planar and opposite to (e.g., parallel to) the planar exterior surface 244 across the window portion 223 of the cover. Although the beveled region 253 is also planar, the beveled region defines a bevel angle θ with respect to the interior surface 242 in the window region. By the way of example, the bevel angle θ may range from 7 degrees to 25 degrees, from 10 degrees to 20 degrees, or from 7 degrees to 15 degrees.

As shown in FIG. 2, the beveled region 253 defines a variation in thickness of the cover member 232. As a specific example, the cover member 232 has a thickness T₂ in the peripheral portion 225 that is less than a thickness T₁ of the window portion 223 of the cover 222 due to the beveled region 253. The thickness of the cover member 232 gradually increases with increasing distance from the side surface 246.

The coating 250 is disposed along the interior surface 242 of the cover member 232 in the peripheral portion 225 of the cover 222. In some embodiments, the coating 250 may be configured to at least partially reflect visible light transmitted through the cover member 232 and incident on the coating 250 while obscuring view of components of the electronic device positioned below the peripheral portion 225 of the cover 222. The coating 250 may include one or more ink coatings that comprise a pigment or dye. In some embodiments, the coating 250 may further include an optical coating positioned between the interior surface 242 of the cover member 232 and the one or more ink coatings. The optical coating may extend along the interior surface 242 and along at least a portion of the side surface 246. The thickness of coating 250 as shown in FIG. 2 is exemplary rather than limiting. The optical coating and the one or more ink coatings may be similar to the optical coatings and ink coatings described with respect to FIG. 7.

When the cover 222 is positioned within the housing, an external viewer may perceive a difference in appearance between the portion of the cover 222 that includes the beveled region 253 and another portion of the cover 222 (e.g., the window portion 223 of the cover). In embodiments, an external viewer perceives a boundary between these two portions due at least in part to the transition 255 between the beveled region 253 and the region 252 of the interior surface 242. The region 252 may be at least partially defined by the window portion 223 of the cover 222. The difference in appearance may be enhanced by the presence of the coating 250 on the beveled region 253 and the absence of the coating 250 on the region 252.

The beveled region 253 of the cover member 232 may contribute to a depth effect of the cover 222. For example, the portion of the cover member 232 that includes the beveled region 253 may appear to be less deep than the thicker window portion of the cover member 232. The depth effect may be aided by the coating 250.

Alternately or additionally, the beveled region 253 may contribute to a refractive effect. For example, a ray of light normally incident on the exterior surface 244 and transmitted through the cover member 232 will be incident on the beveled region 253 at an angle less than ninety degrees due to the bevel angle θ. When this light is reflected from the beveled region 253 towards the exterior surface 244 it will not be normally incident on the exterior surface 244 and therefore may exit the exterior surface 244 at an angle different from ninety degrees. Therefore, an external viewer may perceive a difference between reflected light exiting the peripheral portion 225 of the cover 222 and reflected light exiting the window portion 223 of the cover 223. For example, at least some of the light exiting the peripheral portion 225 of the cover may appear to be “bent” as compared to the light exiting the window portion 223 of the cover.

FIG. 3 shows an example partial cross-sectional view of the electronic device of FIG. 1A. The electronic device 300 includes an enclosure component, the cover 322, that provides an optical effect. The cross-sectional view of FIG. 3 may be along 1-1 in FIG. 1A.

When the cover 322 is positioned within the housing 310, an external viewer may perceive a difference in appearance between the portion of the cover 322 that includes the optical assembly 350 and another portion of the cover 322 (e.g., the window portion 323 of the cover). In some embodiments, the optical effect may be a depth effect and/or a refractive effect. As one example, the depth effect may give the impression that a portion of the cover member 332 varies in thickness although the actual thickness of this portion of the cover member 332 is generally uniform. In some cases, the perceived variation in the thickness of the cover member 332 is similar to the variation in thickness resulting from an interior beveled surface, an example of which was shown in FIG. 2. In other examples, the optical assembly may produce any of the other optical effects described herein, including those described with respect to FIGS. 1A and 1B.

In the example of FIG. 3, the cover 322 includes the cover member 332 and an optical assembly 350 that provides the optical effect. As shown in FIG. 3, the cover 322 defines a window portion 323 and a peripheral portion 325. The window portion 323 is positioned over an active area 373 of the display 372. In embodiments, the peripheral portion 325 surrounds the window portion 323 of the cover 322.

The cover member 332 defines a planar exterior surface 344 that extends across the window portion 323 and most of the peripheral portion 325 of the cover 322. The interior surface 342 is planar and parallel to the planar exterior surface 344 across the window portion 323 and across most of the peripheral portion 325 of the cover. The cover member 332 also defines a relatively small, beveled corner 343 between the interior surface 342 and the side surface 346. A beveled corner is also present between the exterior surface 344 and the side surface 346. The exterior surface of the cover member 332 may alternately be referred to herein as the front surface and the interior surface of the cover member 332 may alternately be referred to herein as the rear surface.

The optical assembly 350 is located in the peripheral portion 325 of the cover 322. As shown in FIG. 3, the optical assembly 350 is provided along an interior surface 342 and a side surface 346 of the cover member 332 in the peripheral portion 325. At least a portion of the cover member 332 that is coupled to the optical assembly 350 (at least part of the peripheral portion 325) has a thickness that is similar to a thickness T₃ of the window portion 323 of the cover member 332 that is positioned over the active area 373 of the display 372. However, the optical assembly 350 may give the impression that this portion of the cover member 332 has a thickness that is different from the window portion 323 of the cover member 332 that is positioned over the active area 373 of the display 372.

The optical assembly 350 may define closed loop that defines a frame (alternately, border) around the active area 373 of the display 372. The optical assembly 350 may be positioned over the inactive area 375 of the display 372, but not over the active area of the display 372. The assembly 350 may be configured to obscure the inactive area 375 of the display 372 from view as well as providing a depth effect.

As previously discussed with respect to FIGS. 1A and 1B, the optical assembly 350 includes at least one optical element that contributes to the optical effect. The optical assembly 350 may also include a light absorbing coating provided behind the optical structure (e.g., behind the optical coating). FIG. 7 shows an enlarged cross-sectional view of an optical assembly 750 that provides an optical effect and the description provided with respect to FIG. 7 with respect to optical assemblies and the elements of the optical assemblies is generally applicable to the disclosure herein and those details are not repeated here.

The electronic device 300 includes an enclosure 305 and a display 372 positioned within an internal cavity 301 defined by the enclosure 305. The housing 310 defines a front opening 303 to the enclosure 305. Furthermore, a portion of the housing 310 extends along the side surface 346 of the cover member 332 and surrounds the cover member 332. The cover 322 is positioned over the display 372 and is coupled to the housing 310. In the example of FIG. 3, the cover 322 is coupled to the internal ledge 311 of the housing. An adhesive may be included in the optical assembly 350 or may be provided as a separate element to facilitate coupling of the cover 322 to the housing. The example of FIG. 3 is not limiting and the cover 322 may be coupled to the housing in other ways, an example of which is shown in FIG. 4. The cover 322 may also be coupled to the display 372. For example, the cover member 332 may be coupled to the display 372 by an adhesive 382. The adhesive 382 may be optically clear. The exterior surface 344 of the cover member may be level with or recessed with respect to a front-facing surface of the housing 310.

FIG. 4 shows another example partial cross-sectional view of the electronic device of FIG. 1A. The electronic device 400 includes an enclosure component, the cover 422, that provides an optical effect. The optical effect may be any of the optical effects previously discussed with respect to FIGS. 1A, 1B, and 3. The cross-sectional view of FIG. 4 may be along 1-1 in FIG. 1A.

The cover 422, the cover member 432, and the optical assembly 450, and the display 472 may be similar to the cover 322, the cover member 332, the optical assembly 350, and the display 372 and the description of these elements is not repeated here. The cover 422 is positioned over the display 472 and is coupled to the housing 410 via the internal ledge 411. In the example of FIG. 4, the cover 422 is coupled to a display frame 476 which in turn is coupled to the internal ledge 411 of the housing. An adhesive may be used to couple the cover to the display frame 476, the display frame 476 to the housing 410, and/or the cover 422 to the display 472 in a similar fashion as previously described with respect to FIG. 3.

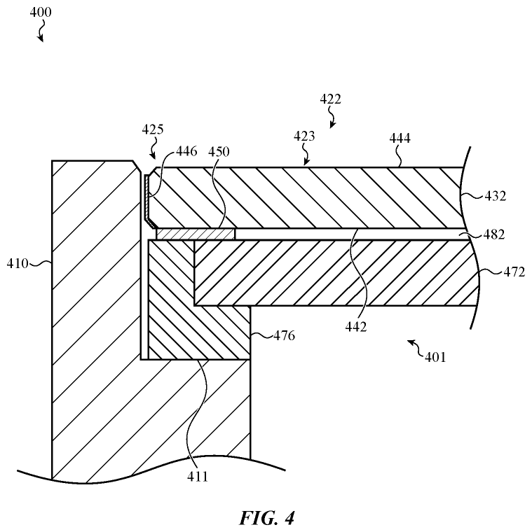

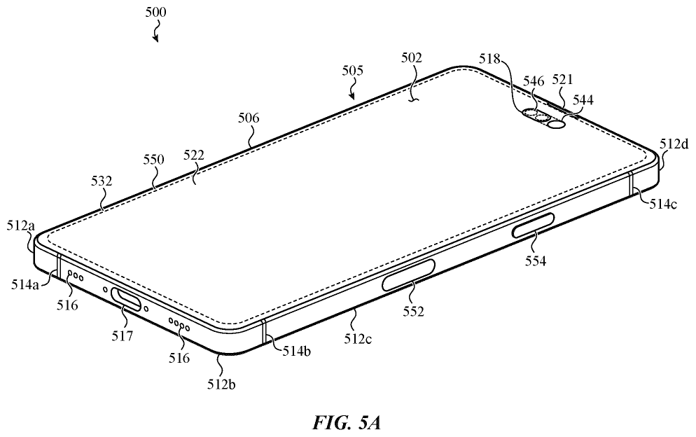

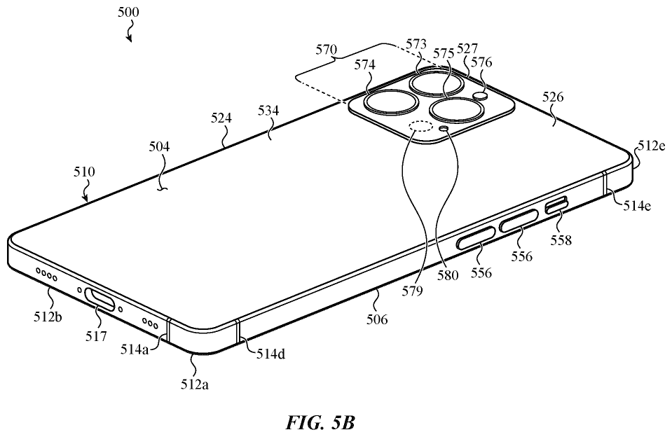

FIGS. 5A and 5B show different views of another electronic device. The electronic device 500 may be a mobile telephone, also referred to herein as a mobile phone. The electronic device 500 includes an enclosure 505. The enclosure 505 includes a cover 522, a cover 524, and a housing 510. The cover 522 may produce an optical effect as described herein due to the optical assembly 550. The cover 522 may at least partially define a front surface 502 and the cover 524 may at least partially define a rear surface 504 of the electronic device.

The cover 522 is positioned over the display and may define a window portion that is positioned over the active area of the display and a peripheral portion that surrounds the window portion, as illustrated in FIG. 3. The cover 522 may include a cover member 532. In embodiments, the cover 522 may be positioned over one or more additional internal components of the electronic device 500 such a front-facing sensing array or a radio-frequency (RF) antenna assembly (which may be a directional antenna assembly). The front-facing sensing array may include one or more camera assemblies (e.g., a camera array), one or more sensor assemblies (e.g., a sensor array), an illumination assembly, or combinations of these. The front sensing array 518 includes a front-facing camera assembly 544 and a front-facing sensor assembly 546. The front sensing array 518 may also include an ambient light sensor, which in some cases may be positioned below the display. The cover 522 may define an opening 521 over a speaker.

In the example of FIGS. 5A and 5B, the cover 524 is positioned over a sensing array 570. The portion 527 of the cover 524 that is positioned over the sensing array may be thicker than another portion 526 of the cover 524. As shown in FIGS. 5A and 5B, the portion 527 may protrude with respect to the portion 526 and may therefore be referred to as a protruding portion. The cover member 534 may be thicker in the portion 527 than in the portion 526 of the cover 526. In implementations in which the portion 527 of the cover 524 is used to protect one or more sensor modules or components, the portion 527 may be referred to as a sensor feature, a camera feature, a sensing array, a camera panel, and/or a camera bump. The portion 527 may define one or more openings for components of the sensing array. In embodiments, the cover 524 may be positioned over one or more internal components of the electronic device 500 such a radio-frequency (RF) antenna assembly (which may be a directional antenna assembly), a component for an inductive coupling wireless charging system, or the like.

The sensing array 570 may include one or more camera assemblies and/or one or more sensor assemblies. In some examples, each of the camera assemblies may include an optical component such as the optical components 573, 574, 575, and 576. The optical components 573, 574, and 575 may be positioned at least partially within an opening in the portion 527 and may be camera modules. The optical component 576 may be an illumination module.

Alternately or additionally, the sensing array 570 may include one or more sensor assemblies, such as the sensor assembly 579. In some embodiments, the sensor assembly 579 may include one or more optical modules. For example, the sensor assembly may include an emitter module, a receiver module, or both. In some cases, the sensor assembly 579 may measure a distance to a target, such as a Lidar sensor assembly which is configured to illuminate an object with light and then detect the reflected light to determine or estimate the distance between the electronic device and the object (e.g., a time of flight (TOF) sensor). In some examples the sensor assembly 579 may be positioned below the cover member 534 (and the cover member 534 may act as a window for the sensor assembly 579). In these examples, the optical properties of the cover member 534 may be suitable for use over one or more optical components of the sensor assembly. For example, the one or more optical components may operate over one or more specified wavelength ranges and the cover member 534 may be configured to have a suitable transmission/transmittance over these wavelength ranges. In other examples, the cover member 534 may define an opening over the sensor assembly and an additional cover member may be placed in or over the opening (and act as a window for the sensor assembly).

The electronic device 500 may include a sensor assembly 580 which is other than an optical component. For example, the sensor assembly 580 may be a microphone which may be positioned at least partially within or below an opening in the portion 527 of the cover 524.

The cover 524 may include an internal coating disposed along an interior surface of the cover member 534. The internal coating may be an ink coating that comprises a pigment or dye. In some embodiments, the internal coating is configured to at least partially reflect visible light transmitted through the cover member 534 and incident on the coating. In some embodiments, an external coating, such as a smudge resistant coating, may be disposed along an exterior surface of the cover member 524 as previously described with respect to FIGS. 1A and 1B.

In the example of FIGS. 5A and 5B, the enclosure 505 also includes a housing 510, alternately referred to as a band. The housing 510 at least partially defines a side surface 506 of the electronic device. In additional examples, the cover 522 and/or the cover 524 may at least partially define a side surface of the electronic device. Each of the cover 522 and the cover 524 may be coupled to the housing 510.

The housing 510 may include one or more members. In the example of FIGS. 5A and 5B, the housing 510 includes multiple members formed from a metal material (e.g., one or more metal segments). In particular, the housing 510 is formed from a series of metal segments (512a, 512b, 512c, 512d, and 512e) that are separated by dielectric segments (514a, 514b, 514c, 514d, and 514e) that provide some extent of electrical isolation between adjacent metal segments (e.g., by preventing electrical conduction through the dielectric segments). For example, a polymer segment (514b) may be provided between a pair of adjacent metal segments (512b, 512c). One or more of the metal segments may be coupled to internal circuitry of the electronic device 500 and may function as an antenna for sending and receiving wireless communication. In alternate embodiments, the housing 510 may include one or more members formed from a glass material, one or more members formed from a ceramic material, one or more members formed from a glass ceramic material, combinations of these, or combinations of these with one or more members formed from a metal material.

The housing 510 may define one or more openings or ports, such as the openings 516 and 517 shown in FIGS. 5A and 5B. The opening 516 may allow (audio) input or output from a device component such as a microphone or speaker. The opening 517 may contain an electrical port or connection.

In addition, the electronic device 500 may include one or more input devices. In the example of FIGS. 5A and 5B, the input devices 552, 554, 556, and 558 have the form of a button and may extend through additional openings in the housing 510.

In addition, the electronic device 500 may include one or more device components that may be part of a wireless communication system. The wireless communication system may be as previously provided with respect to FIGS. 1A and 1B. Furthermore, the electronic device 500 may include one or more groups of antennas that include elements that are configured to communicate via a 5G wireless protocol (including millimeter wave and/or 6 GHz communication signals). In some cases, the electronic device 500 includes one or more directional antennas (or high gain antennas). The multiple directional antennas which have different primary transmission directions.

FIG. 6 shows a front view of a cover that may be included in an electronic device enclosure. At least a portion of the cover 622 may be configured to produce an optical effect, such as a depth effect and/or a refractive effect. As shown, the cover 622 includes a window portion 623 (alternately central portion) and a peripheral portion 625 that defines a perimeter 626. In the example of FIG. 6, the exterior surface 644 of the cover member 632 is facing upwards (out of the plane of the image). When the cover 622 is a display cover, the exterior surface 644 may alternately be referred to as the front surface.

In embodiments, the peripheral portion 625 of the cover may be configured to produce the optical effect. The peripheral portion 625 of the cover 622 may also be configured to obscure or mask an inactive area of a display and/or other internal components or features of the electronic device from view. The cover 622 may be an example of the cover 122, the cover 522, or any other cover described herein. In the electronic device, the cover 622 may be coupled to a housing and positioned over a display as previously described at least with respect to FIGS. 1A and 5A.

The cover 622 includes a cover member 632 and an optical assembly 650 that is configured to produce an optical effect. In the example of FIG. 6, an external viewer may perceive a difference in appearance between the portion of the cover 622 that includes the optical assembly 650 and another portion of the cover 622 that lacks the optical assembly 650 (e.g., the window portion 623). In embodiments, the optical assembly 650 defines a closed loop that defines a frame (alternately, border) around the active area of the display. The optical assembly 650 may be positioned over the inactive area of the display and may be configured to obscure the inactive area of the display from view.

As shown in FIG. 6, the optical assembly 650 includes a first portion 652 and a second portion 654. In some embodiments, the first portion 652 produces at least one optical effect that is different from that of the second portion. As examples, an external observer may perceive a different intensity of reflected light, spectrum of reflected light (e.g., color), and/or amount of diffusely reflected light from the part of the cover 622 that includes the first portion 652 of the optical assembly as compared to the part of the cover 622 that includes the second portion 654 of the optical assembly. In some embodiments, the first portion 652 of the optical assembly 650 is configured to optically simulate a beveled region of the cover member 632. The second region 654 may be configured to provide an opaque border (alternately, frame) around the active area of a display and in some cases may simulate a transition between a beveled region of the interior surface of the cover member and an adjacent substantially flat region of the interior surface. The first portion 652 has a width that is larger than a width of the second portion 654, as is also shown in FIG. 7. The width of the second portion 654 shown in FIG. 6 has been exaggerated for purposes of illustration. In some embodiments, the first portion 652 may extend along a side surface of the cover member (shown in FIG. 7 but not readily visible in the view of FIG. 6). The example of FIG. 6 is not limiting and in additional examples the optical assembly 650 need not include the second portion 654 and/or the first portion 652 need not extend along the side surface of the cover.

The difference in optical effects between the first portion 652 and the second portion 654 of the optical assembly 650 may be obtained by providing different arrangements of the optical assembly elements in these two portions. A detailed description of arrangements of elements optical assemblies is provided with respect to the enlarged cross-sectional view of FIG. 7 and those details are not repeated here.

FIG. 7 shows a partial cross-section view of a cover. The cover 722 includes an optical assembly 750 that is configured to produce an optical effect, such as a depth effect and/or a refractive effect. The optical assembly 750 may also be configured to obscure view of some internal device components positioned below the cover. The cover 722 includes a cover member 732 that defines a window portion 733 that may be positioned over an active area of a display. The cover member 732 also defines a peripheral portion 735. The cover 722 may be an example of the cover 122, the cover 522, the cover 622, or any other cover described herein. The example of FIG. 7 may be an example cross-section view of the cover 622 of FIG. 6 and the cross-sectional view may be along 6-6 in FIG. 6.

As shown in the example of FIG. 7, the optical assembly 750 includes a first portion 752 and a second portion 754. The arrangement of elements of the optical assembly 750 in these two portions is different and may result in the first portion 752 producing at least one optical effect that is different from that of the second portion 754. In some embodiments, the first portion 752 of the optical assembly 750 is configured to optically simulate a beveled region of the cover member 732. The second portion 754 of the optical assembly 750 may be configured to provide an opaque border (alternately, frame) around the active area of a display and in some cases may be configured to simulate a transition between a beveled region of the interior surface of the cover member and an adjacent substantially flat region of the interior surface.

The optical assembly 750 may have a lateral size small enough that it does not extend over the active area of the display. As shown in FIG. 7, the first portion 752 has a width W₁ that is larger than a width W₂ of the second portion 754 of the optical assembly 750. As examples, the width W₂ of the second portion 754 ranges from 50 micrometers to 250 micrometers or from 50 micrometers to 150 micrometers. In some embodiments, the smaller width W₂ of the second portion 754 can provide a simulated transition region that is smaller than a simulated beveled region, similar to the configuration of the beveled cover shown in FIG. 2. In some cases, the width W₁ of the first portion 752 may be larger than a thickness of the cover member T₇. As examples, the width W₁ may range from 1 mm to less than 5 mm or from 1 mm to less than 2 mm.

The first portion 752 of the optical assembly 750 includes a set of surface features 762 along the interior surface 742 of the cover member 732 and an optical coating 764 disposed over the set of surface features 762. Each of the set of surface features 762 and the optical coating 764 may function as an optical element that interacts with light passing through the cover member and into the optical assembly 750. For example, the set of surface features 762 may contribute to a refractive effect as explained in more detail below. The optical coating 764 may be configured to modify the reflection of light back towards an external viewer. The first portion 752 of the optical assembly 750 further includes an ink coating 766 disposed over the optical coating 764. The ink coating 766 may alternately be referred to herein as a rear ink coating or as a second ink coating. An optional clear layer 768 may be disposed over the ink coating 764.

In embodiments, the first portion 752 may define a first coating stack 792. When the set of surface features 762 are provided as a coating, such as a patterned coating, the first coating stack 792 may include a patterned transparent or translucent coating that defines the set of surface features 762 and that is disposed over a first region 782 of the interior surface 742 of the cover member. At least a portion of the first region 782 of the interior surface 742 may be substantially coplanar with a region 786 of the surface defined by the window portion of the cover member 732. In some examples where the cover member 732 defines a beveled corner 743, the first region 782 of the interior surface may be defined to exclude or to include this beveled corner. The first coating stack 792 may include a first portion of the optical coating 764 that is disposed over the patterned transparent or translucent coating. The first coating stack 792 may further include a first portion of the ink coating 766 that is disposed over the first portion of the optical coating 764. The first coating stack 792 may optionally include a first portion of a clear coating 768. An optional adhesion coating (e.g., similar to adhesion coating 1061 of FIG. 10B) may be deposited along the interior surface 742 of the cover member 732 before the surface features 762 are formed. When this adhesion coating is present, the first coating stack 792 may further include the adhesion coating. The description of the adhesion coatings provided with respect to FIG. 10B is generally applicable herein. The first coating stack 792 may have an optical density greater than 1. As shown in FIG. 7, the first coating stack 792 has a width W₃.

When the set of surface features 762 are formed into the cover member 732, the first coating stack 792 may include the first portion of the optical coating 764 and the first portion of the ink coating 766. In this case, the first coating stack 792 may further include the portion of the clear coating 768 and/or the adhesion coating and may have an optical density greater than 1 as discussed above.

The second portion 754 of the optical assembly 750 includes an ink coating 763 disposed along the interior surface 742 of the cover member 732 and an optical coating 764 disposed over the ink coating 763. Because the ink coating 763 is positioned in front of the optical coating 764, absorption of light by the ink coating 763 can reduce the optical effect of the optical coating 764 in the second portion 754 as compared to the first portion 752. The ink coating 763 may alternately be referred to herein as a front ink coating or as a first ink coating. In some embodiments, the set of surface features 762 does not extend into the second portion 754, so that the second portion 754 lacks these surface features. In other embodiments, the ink coating 763 partially overlaps the set of surface features 762 and the second portion 754 may include some of the surface features 762. However, even if the ink coating 763 partially overlaps the set of surface features 762, absorption of light by the ink coating 763 can reduce the optical effect of any surface features of the set of surface features 762 within the second portion 754 as compared to the first portion 752. The second portion 754 further includes an ink coating 766 disposed over the optical coating 764. An optional clear layer 768 may be disposed over the ink coating 764.

The second portion 754 of the optical assembly 750 may define a second coating stack 794 that includes the ink coating 763 disposed over a second region of the interior surface 742. At least a portion of the second region of the surface may be substantially coplanar with a region of the surface defined by the window portion of the cover member 732. In some embodiments, the second region 784 of the interior surface 742 may be defined so that it lacks the surface features of the set of surface features 762 (so that the second region 784 does not overlap the first region 782 of the interior surface 742). In other embodiments, the second region 784 of the interior surface may overlap the first region 782 (e.g., when the ink coating 763 partially overlaps the set of surface features 762). The second coating stack 794 may further include a second portion of the optical coating 764 disposed over the ink coating 763, a second portion of the ink coating 766 disposed over the second portion of the optical coating 764, and, optionally, a second portion of the clear coating 768 disposed over the ink coating 766. As previously discussed with respect to the first portion 752, when an adhesion coating is present, the second coating stack 794 may further include the adhesion coating. The second coating stack 794 may have an optical density greater than 1.

In the second coating stack 794 shown in FIG. 7, the end of the optical coating 764 is set back slightly from the end of the ink coating 763, the end of the ink coating 766 is set back slightly from the end of the optical coating layer 764, and the end of the clear layer 768 is set back slightly from the end of the ink coating 766. The total amount of the setback may be less than the width W₂. This arrangement helps to limit visibility of layers that are positioned behind the ink coating 763. In some cases, one or more layers of the second coating stack 794 may be trimmed to achieve the desired positioning of the end of the layer(s). The one or more layers may be trimmed using a laser or by using other suitable techniques.

The third portion 756 of the optical assembly 750 extends along at least a portion of the side surface 746 of the cover member 732. When the cover member 732 includes a beveled corner 743, the third region 756 may also extend over at least a portion of the beveled corner. The third portion 756 includes the optical coating 764 (e.g., a third portion of the optical coating 764). In contrast to the first portion 752 and the second portion 754 of the optical assembly 750, the third portion 756 may lack an ink coating, such as the ink coating 766, disposed over the optical coating 764. In some embodiments, an adhesion coating may be provided along the side surface 746 and the beveled corner 743 in front of the optical coating 764. The description of the adhesion coatings provided with respect to FIG. 10B is generally applicable herein.

The surface features of the set of surface features 762 may be protruding features, recessed features, or both. The protruding features may be substantially transparent. In some cases, the interaction of light with the set of surface features may contribute to an optical effect. As an example, light reflected from the set of surface features 762 may contribute to the optical effect. Alternately or additionally, light passing through the set of surface features after being reflected from the optical coating 764 may contribute to the optical effect. Without wishing to be bound by any particular belief, at least some of the light exiting the cover 722 after interacting with the surface features may appear to be refracted or “bent” as compared to light reflected from a portion of the cover member (e.g., the window portion 733) that lacks the surface features.

In some embodiments, the surface features may have one or more micro-scale dimensions. As an example, a lateral dimension of the surface features, such as a maximum width or diameter, may be small enough so that individual surface features are not readily perceived at a typical viewing distance by the unaided eye. In some embodiments, the surface features may have a lateral dimension, such as a maximum width or a diameter, which is greater than wavelengths of visible light. As examples each of the surface features may have a lateral dimension that ranges from 1 micrometer to 250 micrometers, 5 micrometers to 50 micrometers, or 50 micrometers to 250 micrometers. In other embodiments, each of the surface features may have a lateral dimension that is within the range from 100 nm to 800 nm. In some cases, adjacent surface features are spaced apart from one another. Therefore, the center to center spacing between adjacent surface features may be greater than the lateral dimension of the surface features. The surface features may have a spacing that ranges from 10 micrometers to 500 micrometers, from 10 micrometers to 100 micrometers, or from 50 micrometers to 200 micrometers. In some cases, the set of surface features may define an array of surface features, such as a regular array of surface features having a substantially uniform spacing. In some examples, the surface features may have a height and/or depth that ranges from 1 micrometer to 20 micrometers, 1 micron to 6 microns, or 2 micrometers to 10 micrometers. In some cases, the surface features of may have a substantially uniform height. In some examples, an average height of the surface features is less than an average spacing between adjacent surface features.

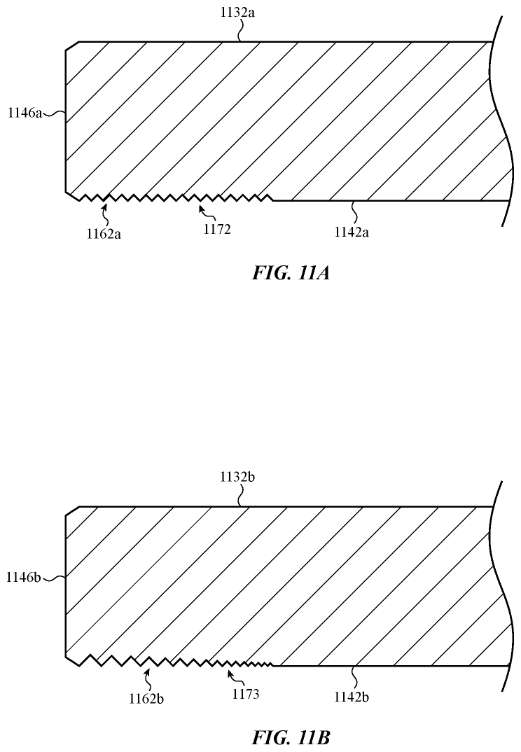

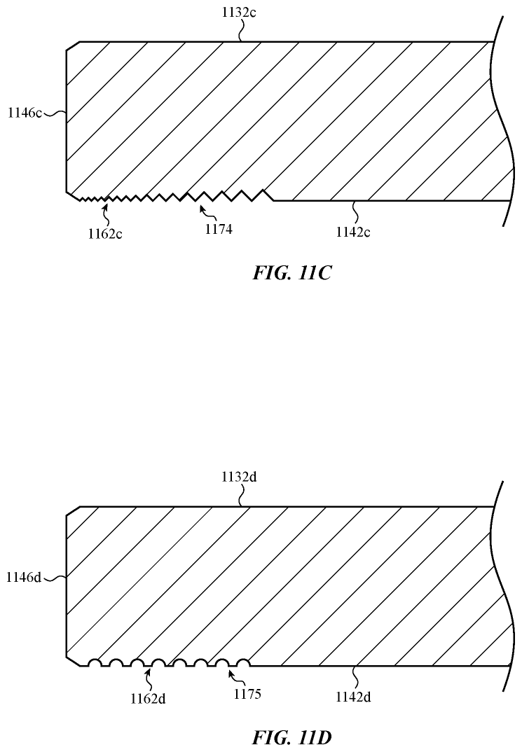

In some embodiments, the spacing, the lateral dimension, and/or the height or depth of the surface features may be varied to tailor the optical effect. In some cases, the variation in the spacing, the lateral dimension, and/or height or depth can vary the interaction of light with the set of surface features. For example, the variation in the size and/or spacing of the surface feature may change the perceived amount of light “bending” and/or diffuse reflection resulting from interaction of light from the surface features, In some cases, the surface features may be different near an edge of the cover member (e.g., near a corner between the interior surface 742 and the side surface 746) than away the edge and the differences in the surface features may contribute to differences in the optical effect. By the way of example, the lateral dimension and the depth of the recessed surface features may be larger nearer the edge of the cover member 732 than further away from the edge in order to contribute to a depth effect in which the cover member 732 appears to have a smaller thickness near the edge then away from the edge (see FIG. 11B). Conversely, the lateral dimension and depth of recesses surface features may be larger near the edge of the cover member 732 to provide an effect of greater thickness near the edge of the cover. As an additional example, a decrease in the spacing between the surface features can lead to a greater influence of the surface features on the way light interacts with the interior surface 742 of the cover member 732. When the density of the surface features is greater near the edge than away from the edge the amount of light, greater diffusion of reflected light may occur near the edge than further away from the edge. As referred to herein, the edge of the cover member 732 may be at least partially defined by the side surface 746.

In some embodiments, the surface features may protrude from the interior surface 742 of the cover member 732. As examples, the surface features may be disposed on the first region 782 of the interior surface 742, such as by depositing a resin on the interior surface or on an adhesion coating deposited on the interior surface. The resin may then be cured to produce the surface features formed of a polymer-based material. The polymer-based material, which may alternately be referred to herein as a polymer material may be substantially transparent or translucent. The polymer-based material may have a refractive index that is the substantially the same as a refractive index of the cover member and may therefore be referred to as being index matched with the cover member. For example, a magnitude (alternately, absolute value) of the difference between the refractive index of the polymer-based material and the refractive index of the cover member may be less than or equal to 0.1. In some embodiments, the resin may be deposited by a screen-printing process to form the set of surface features 762. A screen-printing process using a dot screen (e.g., a halftone screen) may produce cylindrical surface features having a circular or elliptical cross-section. The dot screen may have a uniform areal density of dots to produce a regular array of surface features or may have an areal density that gradually increases or decreases across the width of the first region. In other embodiments, the resin may be deposited on the interior surface 742 using a nanoimprinting process. A nanoimprinting process may produce surface features having a variety of shapes, including, but not limited to, ridges, rings, cylinders, cones, frustums of cones, prisms, and the like. In some cases, the surface features may have a triangular shape, a rectangular shape, or any other suitable shape. When the surface features are produced using a nanoimprinting process, the bases of the surface features may be connected by a thin layer of the polymer-based material.

In embodiments, the surface features may be recessed with respect to the interior surface 742. For example, the surface features may be formed into the interior surface, such as by an etching process. In some cases, the etching process may be a laser etching process. If an adhesion coating is deposited on the interior surface 742, the surface features may be formed through the adhesion coating.

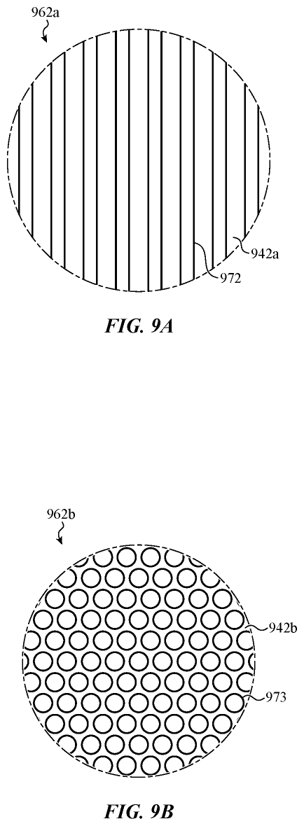

Although individual surface features of the set of surface features 762 are not visible in FIG. 7, the enlarged views of FIGS. 9A through 11B show examples of individual surface features. In some embodiments, the individual surface features need not include a surface that has an orientation similar to that of a simulated bevel surface. For example, a top or side surface of an individual protruding feature need not be tilted at a bevel angle similar to that previously described with respect to FIG. 2.

The optical coating 764 may affect the transmission and/or the reflection of light at the interface between the optical coating 764 and the set of surface features 762. In some examples, the optical coating may comprise at least one layer having an index of refraction that differs from that of the cover member 732. Alternately or additionally, the optical coating 764 may comprise at least one layer having an index of refraction that differs from that of the material from which the set of surface features are formed. For example, the set of surface features may be formed from a material that is different from that of the cover member, such as protruding features formed from a polymer material that has a refractive index that may differ from that of the refractive index of the cover member. As another example, when the set of surface features are formed into the cover the surface features may be formed from a same material as the cover member.

In some embodiments, the optical coating comprises multiple layers. For example, the optical coating may comprise from four to twelve layers. The number of layers may be an even or an odd number or layers. At least two of the layers having differ in their index of refraction (alternately, refractive index). For example, the optical coating may include layers of alternating index of refraction. The thickness of the optical coating may be less than 1 micrometer, such as from 100 nm to 500 mm, may be from 100 nm to 10 micrometers, may be from 100 nm to 5 micrometers, may be from 300 nm to 10 micrometers, or may be from 300 nm to 5 micrometers.

In some embodiments, the optical coating includes multiple dielectric layers. For example, the optical coating may include a first layer formed from a first inorganic dielectric material and a second layer comprising a second inorganic dielectric material. The inorganic dielectric material may be an oxide, a nitride and/or an oxynitride of a metal or metalloid. Suitable oxides include, but are not limited to, a silicon oxide (e.g., SiO₂), niobium oxide (e.g., Nb₂O₅), titanium oxide (e.g., TiO₂), tantalum oxide (e.g., Ta₂O₅), zirconium oxide (e.g., ZrO₂), magnesium oxide (e.g., MgO) and the like. Suitable nitrides include, but are not limited to, silicon nitride (e.g., SiNₓ, Si₃N₄), silicon oxynitride (e.g., SiOₓN_{y}) and the like. The layers of the first and second inorganic materials may be thin and may be deposited by physical vapor deposition or another vacuum deposition technique. In some embodiments, the optical coating comprises alternating oxide and nitride layers that have different indices of refraction.

The optical coating 764 may be configured to modify the reflection of light back towards the external viewer. For example, the optical coating may be configured to reduce reflection of light back towards the external viewer and enhance transmission of light through the optical coating. Alternately or additionally, the optical coating may be configured so that it preferentially reflects certain wavelengths back towards the external viewer, thereby providing a color effect. In some examples, the optical coating may extend along a surface region of the cover member other than the first surface region along which the surface features are formed. In the example of FIG. 7, the optical coating 764 extends from the optical assembly 750 to extend along a side surface 746 of the cover member 732.

In embodiments, the optical coating 764 is an interference coating that includes multiple layers configured to produce optical interference. As an example, the optical coating may be configured to act as an optical filter or an optical reflector that selectively transmits some wavelengths of light in the visible spectrum. Other wavelengths of light in the visible spectrum may be reflected. The surface features may affect the selective transmission and reflection of the optical coating (e.g., when the optical coating conforms to the surface features). In some examples, the performance of the optical coating is different when disposed over the surface features as compared to when the optical coating is disposed over a flat surface. In some cases, the optical coating selectively reflects visible light having a wavelength from about 500 nm to about 800 nm as compared to visible light having a wavelength less than about 500 nm. As another example, the optical coating may be an antireflective coating configured to produce destructive interference of reflected light. As referred to herein, an antireflective coating may still reflect some light back towards an external observer.

The ink coatings 763 and 766 include a pigment or dye that absorbs light in the visible spectrum. In some cases, one or more of the ink coatings 763 and 766 are near neutral in color, with each of a* and b* having a magnitude (absolute value) less than or equal to 3 or less than or equal to 5. The ink coating may have a L* value sufficiently low that the coating appears black. The ink coating 763 and/or the ink coating 766 may have an optical density greater than 1, greater than 3, or greater than 4. Therefore, the ink coating 763 and/or the ink coating 766 may alternately be referred to herein as a light absorbing coating or an opaque coating. In some cases, the ink coating 763 and/or the ink coating 766 may comprise multiple sublayers in order to increase the optical density of the layer. An ink coating including a single layer may have a thickness from 2 micrometers to 10 micrometers and an ink coating including multiple layers may have a thickness from 4 micrometers to 50 micrometers.

In the example of FIG. 7, the cover member 732 defines a beveled corner 743 between the interior surface 742 and the side surface 746. The ink coating 766 of the optical assembly 750 extends onto this beveled corner 743 but does not extend across the beveled corner 743 to the side surface 746. In embodiments, the distance spanned by the beveled corner 743 is smaller than the distance spanned by the interior surface 742 so that the optical effect produced by the optical assembly is primarily due to the portion of the optical assembly 750 that lacks a macroscale bevel. The cover member 732 further defines a beveled corner 745 between the exterior surface 744 and the side surface 746. The example of FIG. 7 is not limiting and in other embodiments the cover member need not define a beveled corner. When the cover 722 is a display cover, the exterior surface 744 may alternately be referred to as the front surface and the interior surface 742 may alternately be referred to as the rear surface.

In the example of FIG. 7, the cover member 732 defines a substantially planar exterior surface 744 and at least a portion of the interior surface 742 is substantially planar and opposite the substantially planar exterior surface 744. For example, the region 786 of the interior surface 742 defined by the window portion 733 of the cover member 732 and at least a portion of the second region 784 of the interior surface 742 may be substantially planar and opposite to the substantially planar exterior surface 744. In some cases, these regions may be flat (alternately, level) to within 2% rather than tilted. When recesses and/or protrusions are formed into the first region 782 of the interior surface 742 then that region of the rear surface 742 may no longer be strictly planar due to the texture. However, a base level of the textured region may be substantially planar.

Furthermore, a thickness of a window portion 733 may be generally equal to a thickness of at least a portion of the cover member 732 along which the optical assembly 750 is provided. In some cases, the thickness of the window portion 733 and the thickness of the portion of the cover member 732 along which the second portion 744 of the optical assembly is provided may be generally the same. In some cases, the thickness of the window portion 733 and the thickness of the portion of the cover member 732 along which the first portion 744 of the optical assembly 750 is provided may be generally the same. The terms generally equal or generally the same take into account relatively small variations in thickness of the cover member 732 that may occur during formation of the cover and when recesses and/or protrusions are formed into the rear surface 742.

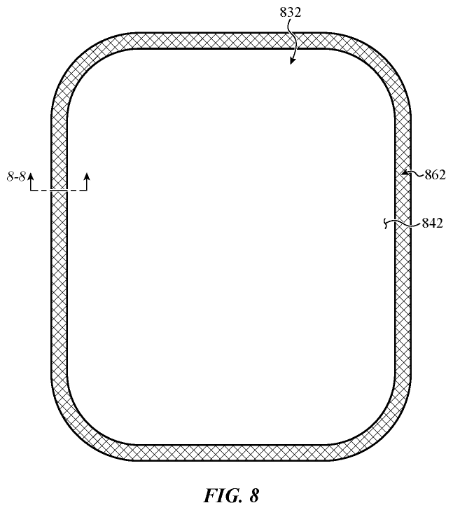

FIG. 8 shows a cover member after formation of a set of surface features and before application of other elements of the optical assembly. In the example of FIG. 8, the cover member 832 is shown with its interior surface 842 facing upwards (out of the plane of the image). When the cover member 832 is to be provided over a display, the interior surface 842 may alternately be referred to as the rear surface. The set of surface features 862 are formed in a peripheral portion of cover member 832 and extend around a peripheral portion of the cover member 832. The cover member may be similar to the cover member 132 or any other cover member described herein and the set of surface features 832 may be similar to the set of surface features 732.

FIG. 9A shows an example of an enlarged view of a set of surface features. In the example of FIG. 9A the set of surface features 962a include ridges 972. In the example of FIG. 9A, the cover member is shown with its interior surface 942a facing upward and the ridges 972 protrude from the interior surface 942a. Each of the ridges 972 defines a longitudinal axis. The set of surface features 962a of FIG. 9A may be an example of an enlarged view of some of the surface features 862 of FIG. 8. However, the complete set of surface features 962a is not shown since the view of FIG. 9A is magnified.

In the view of FIG. 9A, the longitudinal axes of the ridges 972 are generally aligned and define a spacing, a width, and a height. In the example of FIG. 9A, the ridges 972 have flat tops and may define rectangular cross-sections (perpendicular to the longitudinal axes). FIG. 10A illustrates a cross-sectional view of surface features having a rectangular cross-section that define a spacing P, a width W, and a height H. However, this example is not limiting and in other examples the ridges may define other cross-sectional shapes including, but not limited to, a triangular cross-sectional shape. In some cases, the ridges are generally parallel to a perimeter of the cover member. Such ridges may define a series of nested rings. The spacing, the width, and the height of the ridges 972 and methods for forming the ridges 972 may be similar to the spacings and heights of the surface features and methods for forming the surface features described with respect to FIG. 7.

FIG. 9B shows another example of an enlarged view of a set of surface features. In the example of FIG. 9B the set of surface features 962b include cylinder-shaped protrusions 973. In the example of FIG. 9b, the cover member is shown with its interior surface 942b facing upward and the cylinder-shaped protrusions 973 project from the interior surface 942b. The set of surface features 962b of FIG. 9B may be an example of an enlarged view of some of the surface features 862 of FIG. 8. However, the complete set of surface features 962b is not shown since the view of FIG. 9B is magnified.

The cylinder-shaped protrusions 973 are separated from each other and define a spacing. In the example of FIG. 9B, the cylinder-shaped protrusions 973 have a substantially circular cross-section and define a diameter. However, this example is not limiting and in other embodiments, the cylinder-shaped protrusions may have an elliptical cross-section, or the surface features may have another shape such as a cone, a frustrum of a cone, a prism or the like. The spacing, the diameter, and the height of the cylinder-shaped protrusions 973 and methods for forming the cylinder-shaped protrusions 973 may be similar to the spacings, lateral dimensions, and heights of the surface features and methods for forming the surface features described with respect to FIG. 7.

FIG. 10A shows an example of a partial cross-section view of a set of surface features of an enclosure component. The set of surface features 1062a protrude from the interior surface 1042a of the cover member 1032a. As previously discussed with respect to FIG. 7, the set of surface features 1062a may be formed on the interior surface 1042a by depositing a material such as a resin on the interior surface 1042a. The set of surface features 1062a may define a patterned coating. The cover member 1032a further defines an exterior surface 1044a and a side surface 1046a. The cross-sectional view of FIG. 10A may be along line 8-8 in FIG. 8.

In the example of FIG. 10A, the surface features 1072 of the set of surface features 1062a are protruding features that define a height H, a spacing P, and a lateral dimension W. The surface features 1072 also define a generally rectangular cross-section and the lateral dimension W also characterizes the base width of the features. In some cases, the surface features 1072 may define ridges or cylinder-shaped protrusions, as previously described with respect to FIGS. 9A and 9B. In some cases, the surface features 1072 may define a triangular cross-section. The spacing P, the height H₃, and the lateral dimension W of the surface features 1072 may be similar to the spacings, heights, and lateral dimensions of the surface features described with respect to FIG. 7. In additional examples, the bases of the surface features 1072 may be connected by a thin layer, as previously discussed with respect to FIG. 7.

FIG. 10B shows another example of a partial cross-section view of a set of surface features of an enclosure component. In the example of FIG. 10B, an adhesion coating 1061 is deposited on the interior surface 1042b of the cover member 1032b and the set of surface features 1062b are formed on the adhesion coating 1061. The set of surface features 1062b therefore protrude with respect to both the interior surface 1042b and the adhesion coating 1061. The set of surface features 1062a may define a patterned coating. The cross-sectional view of FIG. 10B may be along line 8-8 in FIG. 8.

In the example of FIG. 10B, the surface features 1073 of the set of surface features 1062b are protruding features. The surface features 1073 also define a generally rectangular cross-section. In some cases, the surface features 1073 may define ridges or cylinder-shaped protrusions, as previously described with respect to FIGS. 9A and 9B. In some cases, the surface features 1073 may define a triangular cross-section. The spacing, the height, and the lateral dimension of the surface features 1073 may be similar to the spacings, heights, and lateral dimensions of the surface features described with respect to FIGS. 7 and 10A.

The adhesion coating 1061 may improve adhesion between one or more layers of the optical assembly and the cover member 1032b. The adhesion coating 1061 may be thinner than the ink coating(s) of the optical assembly. For example, the adhesion coating 1061 may have a thickness less than 1 micrometer, such as a thickness from 2 nm to 50 nm. The adhesion coating may be transparent to visible light. In some embodiments, the adhesion coating comprises or is formed of an oxide material, such as a silicon oxide (e.g., SiOₓ), a metal oxide, or a mixed oxide which includes silicon and one or more metals in combination with oxygen. When the cover member 1032b is formed from sapphire material (aluminum oxide), the adhesion may be formed from a silicon oxide material or a mixed silicon aluminum oxide material. As shown in the example of FIG. 10B, the adhesion coating 1061 may be provided over a substantial entirety of the interior surface. In other embodiments, the adhesion coating 1061 may be provided only over a portion of the interior surface and/or may be provided on other surfaces of the cover member 1032b, such as the exterior surface 1044b or the side surface 1046b. An adhesion coating may be provided between the cover member and any of the optical assemblies described herein, and description of suitable adhesion coatings provided with respect to FIG. 10B is generally applicable to the disclosure herein.

FIG. 11A shows another example of a partial cross-section view of a set of surface features formed into a cover member. The set of surface features 1162a are formed into the interior surface 1142a of the cover member 1132a. As previously discussed with respect to FIG. 7, the set of surface features 1162a may be formed into the interior surface 1142a using an etching process. The cover member 1132a further defines a side surface 1146a. The cross-sectional view of FIG. 11A may be along line 8-8 in FIG. 8.

In the example of FIG. 11A, the surface features 1172 of the set of surface features 1162a are recessed features that define a depth, a spacing, and a lateral dimension. The lateral dimension may characterize the base width of the recesses 1172. In the example of FIG. 11A, the depth, the spacing, and the base width are substantially uniform. However, in other examples the depth and/or the spacing of the surface features need not be substantially uniform as shown in the examples of FIGS. 11B and 11C. The surface features 1172 define a generally triangular cross-section. In some cases, the surface features 1172 may define grooves or conical or pyramidal recesses. The cross-sectional shapes illustrated in FIG. 11A are not limiting and the features may have other cross-sectional shapes, such as the rounded shapes illustrated in FIG. 11D. The spacing, the depth, and the base width of the surface features 1172 may be similar to the spacings, depths, and lateral dimensions of the surface features described with respect to FIG. 7.

FIG. 11B shows another example of a partial cross-section view of a set of surface features formed into a cover member. The set of surface features 1162b are formed into the interior surface 1142b of the cover member 1132b and the recessed features 1173 have a triangular cross-sectional shape. In some cases, the surface features 1173 may define grooves or conical or pyramidal recesses. The cross-sectional view of FIG. 11B may be along line 8-8 in FIG. 8.

In contrast to the example of FIG. 11A, the depth and spacing of the features 1173 is not substantially uniform. Instead, the depth, the spacing, and the base width of the features 1173 increase from right to left, with the features closer to the side surface 1146b having a greater depth, spacing, and base width than the features farther away from the side surface 1146b. The spacings, the depths, and the base widths of the surface features 1173 may be similar to the spacings, heights, and lateral dimensions of the surface features described with respect to FIG. 7.

FIG. 11C shows another example of a partial cross-section view of a set of surface features formed into a cover member that vary in size. The set of surface features 1162c are formed into the interior surface 1142c of the cover member 1132c and the recessed features 1174 have a triangular cross-sectional shape. In contrast to the examples of FIGS. 11A and 11B, the depth, the spacing, and the base width of the features 1174 increase from left to right, with the features closer to the side surface 1146c having a lesser depth, spacing, and base width than the features farther away from the side surface 1146c. The spacings, the depths, and the base widths of the surface features 1174 may be similar to the spacings, heights, and lateral dimensions of the surface features described with respect to FIG. 7. The cross-sectional view of FIG. 11C may be along line 8-8 in FIG. 8.

FIG. 11D shows another example of a partial cross-section view of a set of surface features formed into a cover member. The set of surface features 1162d are formed into the interior surface 1142d of the cover member 1132d and the recessed features 1175 have a shape with a rounded bottom. In the example of FIG. 11D, the depth, the spacing, and the base width of the recessed features 1175, are substantially uniform. The spacing, the depth, and the base width of the surface features 1175 may be similar to the spacings, depths, and lateral dimensions of the surface features described with respect to FIG. 7. The cover member 1132d further defines a side surface 1146d. The cross-sectional view of FIG. 11D may be along line 8-8 in FIG. 8.

FIG. 12 shows a block diagram of an example electronic device that can include a display cover or another enclosure component as described herein. The schematic representation depicted in FIG. 12 may correspond to components of the devices depicted in FIGS. 1A, 1B, 5A, and 5B as described above. However, FIG. 12 may also more generally represent other types of electronic devices including an enclosure component as described herein.

In embodiments, an electronic device 1200 may include a display 1202. The display 1202 may include a liquid-crystal display (LCD), a light-emitting diode (LED) display, an LED-backlit LCD display, an organic light-emitting diode (OLED) display, an active layer organic light-emitting diode (AMOLED) display, an organic electroluminescent (EL) display, an electrophoretic ink display, or the like. If the display 1202 is a liquid-crystal display or an electrophoretic ink display, the display 1202 may also include a backlight component that can be controlled to provide variable levels of display brightness. If the display 1202 is an organic light-emitting diode or an organic electroluminescent-type display, the brightness of the display 1202 may be controlled by modifying the electrical signals that are provided to display elements. In addition, information regarding configuration and/or orientation of the electronic device may be used to control the output of the display as described with respect to an input device or mechanism 1212. In some cases, the display is integrated with a touch and/or force sensor in order to detect touches and/or forces applied along an exterior surface of the device 1200.

The device 1200 also includes a processor 1204. The processor 1204 may be operably connected with a computer-readable memory 1208. The processor 1204 may be operatively connected to the memory 1208 component via an electronic bus or bridge. The processor 1204 may be implemented as one or more computer processors or microcontrollers configured to perform operations in response to computer-readable instructions. The processor 1204 may include a central processing unit (CPU) of the device 1200. Additionally, and/or alternatively, the processor 1204 may include other electronic circuitry within the device 1200 including application specific integrated chips (ASIC) and other microcontroller devices. The processor 1204 may be configured to perform functionality described in the examples above.

The device 1200 also includes a power source 1206. In some embodiments, the power source includes a battery that is configured to provide electrical power to the components of the electronic device 1200. The battery may include one or more power storage cells that are linked together to provide an internal supply of electrical power. The battery may be operatively coupled to power management circuitry that is configured to provide appropriate voltage and power levels for individual components or groups of components within the electronic device 1200. The battery, via power management circuitry, may be configured to receive power from an external source, such as an alternating current power outlet. The battery may store received power so that the electronic device 1200 may operate without connection to an external power source for an extended period of time, which may range from several hours to several days.

The memory 1208 may include a variety of types of non-transitory computer-readable storage media, including, for example, read access memory (RAM), read-only memory (ROM), erasable programmable memory (e.g., EPROM and EEPROM), or flash memory. The memory 1208 is configured to store computer-readable instructions, sensor values, and other persistent software elements.

The device 1200 also includes a sensor system 1210. The sensor system 1210 may include one or more sensors or sensor components, such as a force sensor, a capacitive sensor, an accelerometer, a barometer, a gyroscope, a proximity sensor, a light sensor, a microphone, an acoustic sensor, a light sensor (including ambient light, infrared (IR) light, ultraviolet (UV) light), an optical facial recognition sensor, a depth measuring sensor (e.g., a time of flight sensor), a health monitoring sensor (e.g., an electrocardiogram (erg) sensor, a heart rate sensor, a photoplethysmogram (ppg) sensor, a pulse oximeter, a biometric sensor (e.g., a fingerprint sensor), or other types of sensing device. In some cases, the device 1200 includes a sensor array (also referred to as a sensing array) which includes multiple sensors. For example, a sensor array may include an ambient light sensor, a Lidar sensor, and a microphone. In additional examples, one or more camera components may also be associated with the sensor array. The sensor system 1210 may be operably coupled to processing circuitry. In some embodiments, the sensors may detect deformation and/or changes in configuration of the electronic device and be operably coupled to processing circuitry that controls the display based on the sensor signals. In some implementations, output from the sensors system is used to reconfigure the display output to correspond to an orientation or folded/unfolded configuration or state of the device. Example sensors for this purpose include accelerometers, gyroscopes, magnetometers, and other similar types of position/orientation sensing devices.

The input/output mechanism 1212 may include one or more input devices and one or more output devices. The input device(s) are devices that are configured to receive input from a user or the environment. An input device may include, for example, a push button, a touch-activated button, a capacitive touch sensor, a touch screen (e.g., a touch-sensitive display or a force-sensitive display), a capacitive touch button, dial, crown, or the like. In some embodiments, an input device may provide a dedicated or primary function, including, for example, a power button, volume buttons, home buttons, scroll wheels, and camera buttons. The one or more output devices include the display 1202 that renders visual information, which may be generated by the processor 1204. The one or more output devices may also include one or more speakers to provide audio output and/or one or more haptic devices that are configured to produce a haptic or tactile output along an exterior surface of the device 1200. The input/output mechanism may also include a communication port or a communication channel. A communication channel may include one or more wireless interface(s) that are adapted to provide communication between the processor 1204 and an external device, one or more antennas (e.g., antennas that include or use housing components as radiating members), communications circuitry, firmware, software, or any other components or systems that facilitate wireless communications with other devices.

The electronic device 1200 also includes a system 1214 in communication with the elements 1202, 1204, 1206, 1208, 1210, and 1210. In some examples, the system 1214 includes circuitry, such as electronic buses and/or bridges. The system 1213 may also include application specific integrated chips (ASIC) and other microcontroller devices.

As used herein, the terms “about,” “approximately,” “substantially,” “similar,” and the like are used to account for relatively small variations, such as a variation of +/−10%, +/−5%, +/−2%, or +/−1%. In addition, use of the term “about” in reference to the endpoint of a range may signify a variation of +/−10%, +/−5%, +/−2%, or +/−1% of the endpoint value. In addition, disclosure of a range in which at least one endpoint is described as being “about” a specified value includes disclosure of the range in which the endpoint is equal to the specified value.

The following discussion applies to the electronic devices described herein to the extent that these devices may be used to obtain personally identifiable information data. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings. Also, when used herein to refer to positions of components, the terms above, below, over, under, left, or right (or other similar relative position terms), do not necessarily refer to an absolute position relative to an external reference, but instead refer to the relative position of components within the figure being referred to.

What is claimed is:

1. An electronic watch comprising:
a display;
a cover comprising:
a cover member defining a window portion positioned over the display;
a set of surface features formed along a rear surface of the cover member; and
a coating stack surrounding the window portion at the rear surface of the cover member, the coating stack comprising:
an optical coating disposed over the set of surface features and comprising a least one layer having a first index of refraction different than a second index of refraction of the set of surface features; and
a rear ink coating disposed over at least a portion of the optical coating;
a housing coupled to the cover and at least partially surrounding the display; and
a band coupled to the housing.

2. The electronic watch of claim 1, wherein:
a portion of the housing extends along a side surface of the cover member and surrounds the cover member; and
the optical coating is further disposed over at least a portion of the side surface.

3. The electronic watch of claim 2, wherein:
the coating stack is a first coating stack comprising a first portion of each of the optical coating and the rear ink coating; and
the cover further comprises a second coating stack comprising:
a front ink coating disposed over the rear surface of the cover member and positioned between the set of surface features and the window portion;
a second portion of the optical coating disposed over the front ink coating; and
a second portion of the rear ink coating disposed over the optical coating.

4. The electronic watch of claim 3, wherein the set of surface features and the coating stack together create an optical effect that simulates a bevel along the rear surface of the cover member.

5. The electronic watch of claim 3, wherein:
the optical coating selectively transmits light in the visible spectrum; and
the rear ink coating absorbs light transmitted by the optical coating.

6. The electronic watch of claim 1, wherein:
the cover member comprises a sapphire material;
the set of surface features are formed from a transparent polymer material coupled to the sapphire material;
the set of surface features include an array of protruding features; and
the rear surface of the cover member is substantially flat.

7. An electronic device comprising:
a display; and
an enclosure comprising a cover positioned over the display, the cover comprising:
a cover member defining a transparent window portion;
a first coating stack comprising:
a patterned transparent coating disposed over a first region of a rear surface of the cover member;
a first portion of an optical coating disposed over the patterned transparent coating; and
a first portion of a rear ink coating disposed over the first portion of the optical coating; and
a second coating stack defining a border around the transparent window portion at the rear surface of the cover member and comprising:
a front ink coating disposed over a second region of the rear surface that is surrounded by the first region of the rear surface;
a second portion of the optical coating disposed over the front ink coating; and
a second portion of the rear ink coating disposed over the second portion of the optical coating.

8. The electronic device of claim 7, wherein:
the enclosure further comprises a housing that defines a front opening to an internal cavity of the enclosure;
the cover is positioned within the front opening;
the cover member defines a planar front surface; and
at least a portion of the first region of the rear surface is planar and opposite to the planar front surface.

9. The electronic device of claim 8, wherein each of the first coating stack and the second coating stack has an optical density greater than 1.

10. The electronic device of claim 8, wherein:
the optical coating comprises multiple dielectric layers;
a refractive index of a first layer of the multiple dielectric layers is less than a refractive index of the cover member; and
a refractive index of a second layer of the multiple dielectric layers is greater than the refractive index of the cover member.

11. The electronic device of claim 10, wherein:
the optical coating extends over a side surface of the cover member; and
the optical coating is configured to produce destructive interference for at least some wavelengths of visible light.

12. The electronic device of claim 7, wherein:
the patterned transparent coating defines an array of cylinder-shaped protrusions; and
an average height of the cylinder-shaped protrusions of the array of cylinder-shaped protrusions is less than an average spacing between adjacent cylinder-shaped protrusions of the array of cylinder-shaped protrusions.

13. The electronic device of claim 7, wherein:
the patterned transparent coating defines a set of protruding features; and
an areal density of the protruding features of the set of protruding features varies across the first region and is greater near a corner between the rear surface and a side surface of the cover member.

14. The electronic device of claim 13, wherein the patterned transparent coating is index matched to the cover member.

15. An electronic device comprising:
a display;
a housing at least partially surrounding the display; and
a cover coupled to the housing and comprising:
a transparent cover member defining a central portion positioned over an active area of the display and a peripheral portion surrounding the central portion; and
an optical assembly at the peripheral portion of the transparent cover member and comprising:
a set of surface features formed along a rear surface of the transparent cover member;
a first ink coating defining a border around the active area of the display and disposed over the rear surface, the first ink coating at least partially surrounded by the set of surface features;
an optical coating disposed over the first ink coating, the set of surface features, and along at least a portion of a side surface of the transparent cover member; and
a second ink coating disposed over a portion of the optical coating.

16. The electronic device of claim 15, wherein:
a front surface of the cover defines a first portion of the front surface of the electronic device;
the housing defines a second portion of the front surface of the electronic device and an internal ledge; and
the optical assembly further comprises a clear coating disposed over the second ink coating and the clear coating is coupled to the internal ledge of the housing.

17. The electronic device of claim 16 wherein:
the optical coating defines an optical filter that selectively reflects light in the visible spectrum; and
the optical assembly obscures an inactive area of the display and the internal ledge from view.

18. The electronic device of claim 17, wherein the peripheral portion of the cover appears to have a depth that is less than a depth of the central portion.

19. The electronic device of claim 15, wherein the set of surface features includes transparent protruding features deposited on the transparent cover member.

20. The electronic device of claim 15, wherein the set of surface features includes recesses formed into the transparent cover member.
